(19) United States
(12) Patent Application Publication
(10) Pub. No.: US 2009/0092168 A1
(43) Pub. Date: Apr. 9, 2009

(54) LASER MODULE AND OPTICAL PICKUP DEVICE

(75) Inventors: Kiyoshi Yamauchi, Kanagawa (JP); Kazuhiko Nemoto, Kanagawa (JP); Tetsuya Konno, Miyagi (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 12/242,094

(22) Filed: Sep. 30, 2008

(30) Foreign Application Priority Data
Oct. 5, 2007 (JP) 2007-261552

(51) Int. Cl. H01S 3/08

(52) U.S. Cl. 372/107

(57) ABSTRACT

A laser module includes a stem provided with a device mounting structure; a light emitting device mounted onto the stem by use of the device mounting structure a tubular cap fixed to the stem in the state of surrounding the light emitting diode and provided with an aperture through which to pass laser light emitted by the light emitting device; and a light transmitting plate fixed, by use of a bonding material, to an inside surface of the cap in the state of closing the aperture. An annular projection projecting to the inside of the cap in the optical axis direction of the laser light is provided at a peripheral edge part of the aperture of the cap, and the light transmitting plate is fixed to the inside surface of the cap inclusive of the projection by use of the bonding material.

### CROSS REFERENCES TO RELATED APPLICATIONS

The present invention contains subject matter related to Japanese Patent Application JP 2007-261552, filed in the Japan Patent Office on Oct. 5, 2007, the entire contents of which being incorporated herein by reference.

### BACKGROUND OF THE INVENTION

1. Field of the Invention

The present invention relates to a laser module used as a pickup light source for recording/reproducing of data into/from an optical disk, and an optical pickup device having the laser module.

2. Description of Related Art

FIG. 8 is a sectional view showing the configuration of a laser module 50 according to the related art. In FIG. 8, a heat sink 52 is provided on an upper surface 51A of a stem 51. A light emitting device 54 is mounted onto the heat sink 52 through a sub-mount 53. The light emitting device 54 is surrounded by a cap 55 attached to the upper surface 51A of the stem 51. The cap 55 is provided in its top part with an aperture 56 through which to pass laser light emitted by the light emitting device 54. The aperture 56 is closed with a transparent window glass 57. The window glass 57 is fixed to the inside surface of the cap 55 by use of a low melting point glass 58. In addition, a lead pin 59 is attached to the stem 51. In this laser module 50, the laser light emitted from the light emitting device 54 is transmitted through the window glass 57, to be emitted to the exterior through the aperture 56 of the cap 55.

In the laser module 50 according to the related art, the bottom surface of the 55 formed from a metal in a hat shape is joined to the upper surface 51A of the stem 51 by resistance welding or the like, and the window glass 57 is bonded to the inside surface of the cap 55 by use of the low melting point glass 58, whereby the inside of the cap 55 (the space in which the light emitting device 54 is mounted) is sealed off in a gas-tight condition. As this kind of laser module, for example, one that is disclosed in Japanese Patent Laid-open No. 2007-201412 has been known.

### SUMMARY OF THE INVENTION

Meanwhile, in the process of manufacturing the laser module, the window glass 57 is bonded to the cap 55 prior to joining the cap 55 to the stem 51. Besides, in the step of bonding the window glass 57 to the cap 55, first, a tablet of the low melting point glass 58 formed in a ring-like shape according to the inner diameter of the cap 55 and the diameter of the aperture 56 is dropped into the inside of the cap 55 placed upside down (onto the back side of the cap top part). Next, the window glass 57 is dropped into the inside of the cap 55 so as to lie on the tablet of the low melting point glass 58. Subsequently, the low melting point glass 58 is softened by heating to a temperature of around 600° C., for example, and, in this condition, the window glass 57 is lightly pushed so as to permit the low melting point 58 to come around to the periphery of the window glass 57.

In the step of bonding the window glass 57 as above, a portion of the low melting point glass 58 softened by heating flows out to the inside (the diameter-reducing side) of the aperture 56 of the cap 55. In this case, as shown in FIG. 9A, the effective diameter D for emitting of the laser light is reduced by 2α from the diameter of the aperture 56, where α is the size of protrusion of the low melting point glass 58 having flowed out to the inside of the aperture 56.

Especially, in recent years, there has been the demand for reducing the size of laser modules. When the outer diameter φβ of the cap 55 and the diameter of the aperture 56 are comparatively reduced in order to meet the demand, as shown in FIG. 9B, the influence of the protrusion size α attendant on the flow-out of the low melting point glass 58 is comparatively increased. As a result, the effective diameter D may be reduced beyond a usable limit. The usable limit of the effective diameter D is determined by the position of the light emitting device 54 and the radiation angle of the laser light emitted therefrom. Therefore, in order to reduce the size of the laser module, the protrusion size α of the low melting point glass 58 has to be suppressed to a low value, and a large effective diameter D has to be secured thereby.

Besides, if the tablet thickness of the low melting point glass 58 used in the step of bonding the window glass 57 is reduced in order to suppress the size of protrusion of the low melting point glass 58, there would be the problem that, when the low melting point glass 58 softened by heating is pressed by the window glass 57, the low melting point glass 58 may fail to be distributed sufficiently to the whole area of the bonded part of the window glass 57, whereby the sealing performance at the bonded part may be spoiled. Accordingly, on the basis of manufacture of the laser module, there has been a limit to the reduction in the filling amount of the low melting point glass 58 through reducing the tablet thickness.

In accordance with an embodiment of the present invention, there is provided a laser module including: a stem provided with a device mounting structure; a light emitting device mounted onto the stem by use of the device mounting structure; a tubular cap fixed to the stem in the state of surrounding the light emitting diode and provided with an aperture through which to pass laser light emitted by the light emitting device; and a light transmitting plate fixed, by use of a bonding material, to an inside surface of the cap in the state of closing the aperture, wherein an annular projection projecting to the inside of the cap in the optical axis direction of the laser light is provided at a peripheral edge part of the aperture of the cap, and the light transmitting plate is fixed to the inside surface of the cap inclusive of the projection by use of the bonding material.

In the laser module and an optical pickup device using the same according to embodiments of the present invention, a configuration is adopted in which the annular projection is formed at the peripheral edge part of the aperture of the cap, and the light transmitting plate is fixed to the inside surface of the cap inclusive of the projection by use of the bonding material. This ensures that, in bonding the light transmitting plate to the inside surface of the cap at the stage of manufacturing the laser module, it is possible to secure a sufficient filling amount of the bonding material and, simultaneously, to suppress the size of protrusion of the bonding material to the inside of the aperture.

Thus, according to the present invention, it is possible to secure a large effective diameter for emitting laser light, without spoiling the sealing performance at a bonded part of the light transmitting plate. Consequently, it is possible to appropriately and easily cope with a reduction in the size of the laser module.

### BRIEF DESCRIPTION OF THE DRAWINGS

FIG. 1 is a partly broken perspective view showing the configuration of a laser module according to a first embodiment of the present invention;

FIG. 2 is a sectional view showing the configuration of the laser module according to the first embodiment;

FIG. 3 is a sectional view showing the state of a cap before attached to a stem;

FIG. 4 is a sectional view showing a laser module according to a second embodiment of the invention;

FIG. 5 illustrates an example of a mounting structure for the laser module according to the second embodiment;

FIG. 6 illustrates a mounting structure for a laser module according to the related art;

FIG. 7 illustrates another example of the mounting structure for the laser module according to the second embodiment;

FIG. 8 is a sectional view showing the configuration of a laser module according to the related art; and

FIGS. 9A and 9B illustrate a trouble in the laser module according to the related art.

### DETAILED DESCRIPTION OF THE PREFERRED EMBODIMENTS

Now, specific embodiments of the present invention will be described in detail below, referring to the drawings.

### First Embodiment

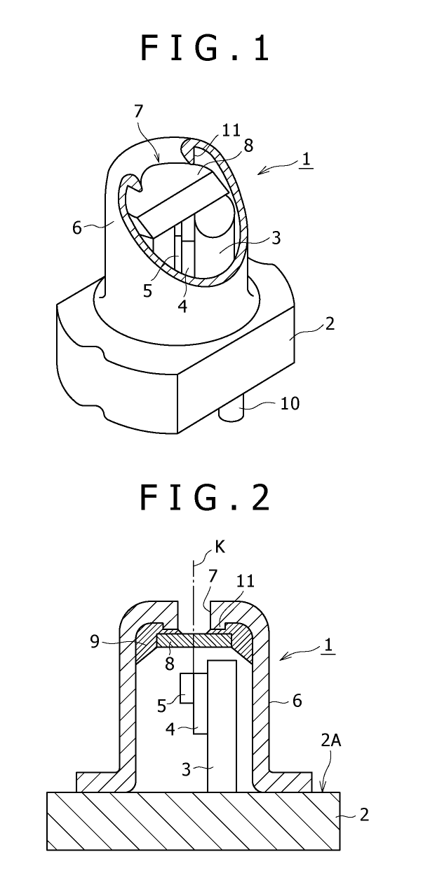

FIG. 1 is a partly broken perspective view showing the configuration of a laser module according to a first embodiment of the present invention, and FIG. 2 is a sectional view showing the configuration of the laser module. In FIGS. 1 and 2, the laser module 1 has a stem 2 as a base member. The stem 2 includes a metallic material with a high thermal conductivity (for example, a copper-based material). A heat sink 3 forming an integral structure together with the stem 2 is provided on an upper surface of the stem 2. The heat sink 3 is formed in the shape of a tetragonal prismatic block. Like the stem 2, the heat sink 3 includes a metallic material with a high thermal conductivity.

A light emitting device 5 is mounted onto one side surface of the heat sink 3 through a sub-mount 4. The heat sink 3 and the sub-mount 4 constitutes a device mounting structure. The device mounting structure herein means a structure which is used for mounting the light emitting device 5 onto the stem 2. The sub-mount 4 includes aluminum nitride, for example. One surface of the light emitting device 5 is joined to one surface of the sub-mount 4, and the other surface of the sub-mount 4 on the other side is joined to one side surface of the heat sink 3.

The light emitting device 5 includes a semiconductor device (for example, a laser diode or the like) in the shape of a chip. The optical axis K of laser light emitted from the light emitting device 5 is set to be orthogonal to the major surface (upper surface) of the stem 2. The light emitting device 5 is surrounded by a tubular cap 6 mounted to the upper surface 2A of the stem 2. The cap 6 is provided for sealing off, in a gas-tight condition, a mounting space for the light emitting device 5 which is mounted onto the stem 2 by use of the heat sink 3 and the sub-mount 4 as above-mentioned.

The cap 6 is formed in a hat shape from a thin metal sheet by press working. The cap 6 is formed by use of a metallic material such as, for example, covar. Covar is an iron (Fe)-nickel (Ni)-cobalt (Co) alloy with a coefficient of thermal expansion reduced to the same level as that of glass. The bottom surface of the cap 6 is firmly joined to the upper surface 2A of the stem 2 by resistance welding or the like. The cap 6 is provided in its top part with an aperture 7 through which to pass the laser light emitted from the light emitting device 5.

The aperture 7 is formed in a circular shape as viewed along the direction of the optical axis K. The aperture 7 is shut up with a window glass 8. The window glass 8 includes a transparent glass substrate which is circular in front view. The window glass 8 is fixed to the inside surface of the cap 6, as a light transmitting plate. The window glass 8 is fixed to the inside surface of the cap 6 by use of a low melting point glass 9 serving as a bonding material. The bonding material to be used to attach the window glass 8, desirably, is impermeable to air and moisture and has a coefficient of thermal expansion between the coefficients of thermal expansion of the cap 6 and the window glass 8.

A lead pin 10 is attached to the stem 2. If necessary, a plurality of (generally, two or three) lead pins 10 are provided. In FIG. 2, the lead pin or pins 10 are omitted.

In addition, a projection 11 is formed at a peripheral edge part of the aperture 7 of the cap 6. The projection 11 is formed in an annular shape along the edge of the aperture 7. The projection 11 is formed in the state of projecting to the inside of the cap 6 in the optical axis direction of the laser light (the vertical direction in FIG. 2). The projection 11 is formed as one body with the cap 6 by, for example, bending an edge part of the aperture 7 to the inner side in forming the cap 6 by press working. On the other hand, the window glass 8 serving as the light transmitting plate is fixed to the inside surface of the cap 6 inclusive of the projection 11, by use of the low melting point glass 9. Therefore, the space in the periphery of the window glass 8 is filled with the low melting point glass 9, and a portion of the low melting point glass 9 comes to fill the gap between the projection 11 and the window glass 8.

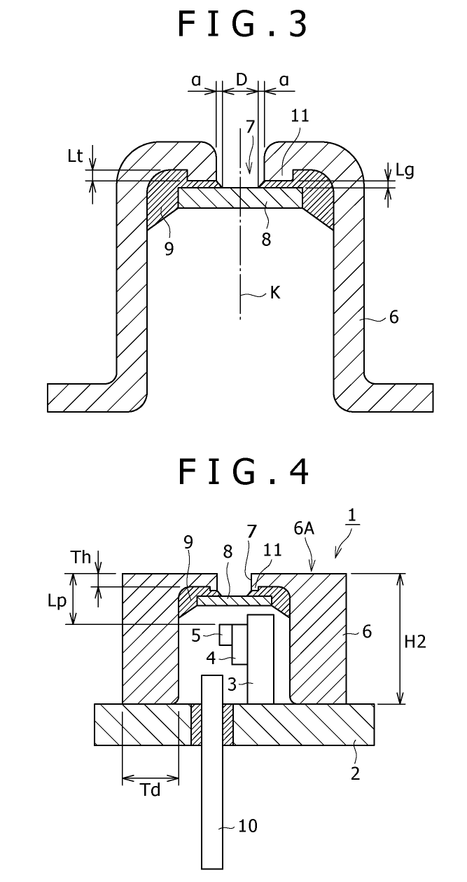

FIG. 3 is a sectional view showing the state of the cap 6 before mounted to the stem 2. In FIG. 3, let the projection size of the projection 11 in the optical axis direction of the laser light be “Lt,” and let the spacing between the projection 11 and the window glass 8 be “Lg,” then these sizes are preferably in the relation of Lt≈Lg, more preferably in the relation of Lt≧Lg. For example, when it is assumed that the spacing between the top part of the cap 6 and the window glass 8 in the absence of the projection 11 is set to 100 μm, it is favorable to set the projection size Lt of the projection 11 to 50 μm, namely, one half of the spacing. In that case, the spacing Lg between the projection 11 and the window glass 8 is set to be comparable to the projection size Lt of the projection 11.

In the structure wherein the projection 11 is thus formed at the aperture 7 of the cap 6, the distance (Lg) between the cap 6 and the window glass 8 is locally reduced in the area where the projection 11 is formed. Therefore, in bonding the window glass 8 to the inside surface of the top part of the cap 6 at the stage of manufacturing the laser module 1, it is possible to secure a sufficient filling amount of the low melting point glass 9 needed to secure the sealing performance at the bonded part and, simultaneously, to suppress the protrusion size α with regard to protrusion of the low melting point glass 9 to the inside of the aperture 7. Consequently, it is possible to secure a larger effective diameter D for emission of the laser light, as compared to the case of bonding the window glass 8 by use of the same amount (the same tablet thickness) of the low melting point glass 9 in a laser module without the projection 11 (a laser module in the related art).

### Second Embodiment

FIG. 4 is a sectional view showing the configuration of a laser module according to a second embodiment of the present invention. In the second embodiment, a projection 11 is formed at a peripheral edge part of an aperture 7 in a cap 6 in the same manner as in the first embodiment, but the structure of the cap 6 as a whole is different from that in the first embodiment.

Specifically, in the first embodiment above, the cap 6 as a whole has been formed in a hat shape with a uniform material thickness by press working of a thin metal sheet used as a material for the cap 6. On the other hand, in this second embodiment, the cap 6 is formed by forging, casting or gouging (cutting), whereby the cap 6 as a whole is formed in a hollow cylindrical shape such that the material thickness Td in the diameter direction of the cap 6 is greater than the material thickness Th in the optical axis direction (the vertical direction in FIG. 4) at the periphery of the aperture 7. More specifically, where the material thickness Th in the optical axis direction at the periphery of the aperture 7 is set to 0.2 mm, it is favorable that the material thickness Td in the diameter direction of the cap 6 is set to 0.4 mm, namely, which is equivalent to twice the material thickness Th. In addition, an upper end surface 6A of the cap 6 is formed to be a flat surface parallel to the bottom surface of the cap 6.

Incidentally, in the case of producing the cap 6 by casting, the cap 6 must be finished to the predetermined dimensions by a finishing work (cutting work or the like) after casting. On the other hand, in the case of producing the cap 6 by forging or cutting, the cap 6 can be machined to the predetermined dimensions without such a finishing work. In addition, the material constituting the cap 6 is not limited to covar and may be other metallic material, for example, copper. In that case, however, the kind of the bonding material must be changed according to the material constituting the cap 6.

Here, in the laser module 1 according to the second embodiment of the present invention, the material thickness Td in the diameter direction of the cap 6 is greater than that in the first embodiment above, and the heat capacity of the cap 6 is greater accordingly. Therefore, the heat from the light emitting device 5 can be efficiently released to the exterior through utilizing the thick peripheral part of the cap 6.

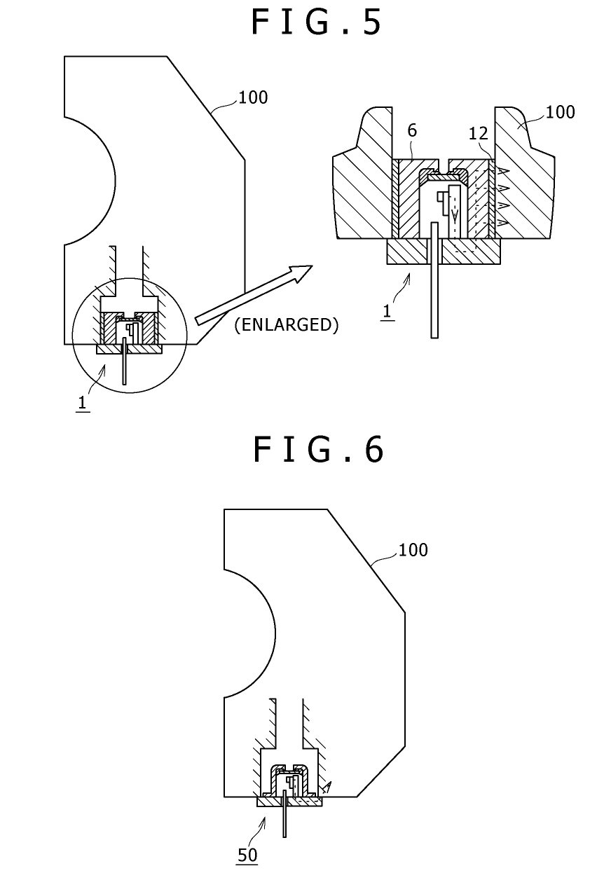

Specifically, as shown in FIG. 5, in the case of attaching the laser module 1 in the second embodiment to a slide base 100 of an optical pickup device, the gap between the outer peripheral surface of the cap 6 and the inner peripheral surface of the slide base 100 opposed thereto may be filled with a highly heat-conductive resin (for example, radiating silicone) 12, whereby the heat generated in the light emitting device 5 can be released to the slide base 100 through the sub-mount 4, the heat sink 3, the stem 2 and the cap 6 along a heat transfer path indicated by dotted-line arrows in the figure. The slide base 100 is provided in the optical pickup device so as to permit reciprocating motions in the radial direction of an optical disk into/from which data is written/read.

On the other hand, in the case of attaching a laser module 50 in the related art (or in the first embodiment) to the slide base 100, as shown in FIG. 6, the heat generated in the light emitting device 5 is released to the slide base 100 through the sub-mount 4, the heat sink 3 and the stem 2 along a heat transfer path indicated by a dot-dash-line arrow in the figure. Therefore, the thermal contact area between the laser module 1 and the slide base 100 is greater, and the thermal resistance is smaller accordingly, in the second embodiment than in the first embodiment. Thus, by adopting the laser module 1 according to the second embodiment, a higher radiating performance can be obtained.

Besides, in the case of forming the cap 55 in a hat shape by press forking of a thin metal sheet as in the laser module 50 according to the related art, an error in the height size H1 (see FIG. 8) of the cap 55 is liable to be generated, due also to the influence of drawability of the cap material. Thus, the accuracy of the height size H1 of the cap 55 is lowered. In view of this, as shown in FIG. 6, in the case of attaching the laser module 50 according to the related art to the slide base 100, the upper surface 51A of the stem 51 is adopted as a mounting reference surface, and the mounting reference surface is abutted to the slide base 100. This applied also to the laser module 1 according to the first embodiment.

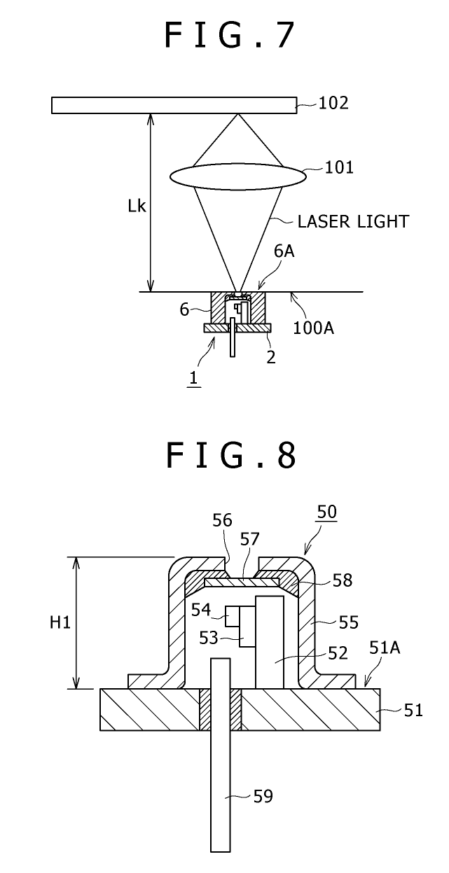

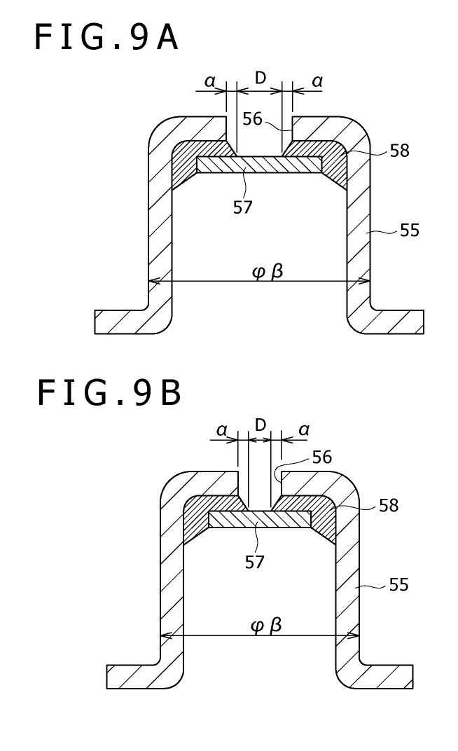

On the other hand, in the case of forming the cap 6 in a hollow cylindrical shape by forging, casting or cutting, the material thickness Td in the diameter direction of the cap 6 is set greater, so that an error in the height size H2 of the cap 6 is not liable to be generated. Thus, a high accuracy can be insured as to the height size H2 of the cap 6. Therefore, as shown in FIG. 7, position matching in the optical axis direction can be achieved by only abutting the upper end surface 6A of the cap 6 to a module mounting surface 100A of the slide base 100.

In addition, the distance Lp (see FIG. 4) from a light emitting point of the light emitting device 5 to the upper end surface 6A of the cap 6 conforming to the mounting reference surface of the laser module 1 is shortened, as compared to the case where the upper surface 2A of the stem 2 is conformed to the mounting reference surface of the laser module 1. Consequently, for example in the case where the laser light emitted from the laser module 1 is converged by an objective lens 101 to irradiate the optical disk 102 with the converged laser light, as shown in FIG. 7, the distance Lk from the mounting reference surface (6A) of the laser module 1 to the optical disk 102 to be irradiated with the laser light can be set with high accuracy.

It should be understood by those skilled in the art that various modifications, combinations, sub- combinations and alterations may occur depending on design requirements and other factors insofar as they are within the scope of the appended claims or the equivalents thereof.

What is claimed is:

1. A laser module comprising:
a stem provided with a device mounting structure;
a light emitting device mounted onto said stem by use of said device mounting structure;
a tubular cap fixed to said stem in the state of surrounding said light emitting device and provided with an aperture through which to pass laser light emitted by said light emitting device; and
a light transmitting plate fixed, by use of a bonding material, to an inside surface of said cap in the state of closing said aperture,
wherein an annular projection projecting to the inside of said cap in the optical axis direction of said laser light is provided at a peripheral edge part of said aperture of said cap, and
said light transmitting plate is fixed to the inside surface of said cap inclusive of said projection by use of said bonding material.

2. The laser module as set forth in claim 1,
wherein said cap is formed in a hollow cylindrical shape such that the material thickness in the diameter direction of said cap is greater than the material thickness in the optical axis direction of the periphery of said aperture.

3. An optical pickup device comprising
a laser module including
a stem provided with a device mounting structure,
a light emitting device mounted onto said step by use of said device mounting structure,
a tubular cap fixed to said stem in the state of surrounding said light emitting device and provided with an aperture through which to pass laser light emitted by said light emitting device, and
a light transmitting plate fixed, by use of a bonding material, to an inside surface of said cap in the state of closing said aperture,
wherein an annular projection projecting to the inside of said cap in the optical axis direction of said laser light is formed at a peripheral edge part of said aperture of said cap, and
said light transmitting plate is fixed to the inside surface of said cap inclusive of said projection by use of said bonding material.
